(19) United States
(12) Patent Application Publication
(10) Pub. No.: US 2025/0305957 A1
(43) Pub. Date: Oct. 2, 2025

(54) BONDED STATE PREDICTION SYSTEM, BONDED STATE PREDICTION METHOD, BONDED STATE PREDICTION PROGRAM AND METHOD FOR PRODUCING BONDED ARTICLE

(71) Applicant: KONICA MINOLTA, INC., Chiyoda-ku, Tokyo (JP)

(72) Inventors: Chiyoko TAKEMURA, Tokyo (JP); Tetsuya YAMADA, Tokyo (JP); Yasushi OKUBO, Tokyo (JP)

(73) Assignee: KONICA MINOLTA, INC., Chiyoda-ku, Tokyo (JP)

(21) Appl. No.: 18/864,147

(22) PCT Filed: May 9, 2023
(86) PCT No.: PCT/JP2023/017451

§ 371 Date: Nov. 8, 2024

(30) Foreign Application Priority Data
May 12, 2022 (JP) 2022-078942

(51) Int. Cl. G01N 21/64

(52) U.S. Cl. CPC G01N 21/6456; G01N 21/6428; G01N 2021/6439

(57) ABSTRACT

A bonded state prediction system according to the present invention predicts the bonded state of an adhesive object and an adherend when the adhesive object is bonded to the adherend; and this bonded state prediction system comprises a data acquisition unit which acquires two or more pieces of data including physical property information of the object on the two-dimensional coordinates, and a bonded state prediction unit which predicts the bonded state of the object and the adherend using the thus-acquired two or more pieces of data.

### TECHNICAL FIELD

The present invention relates to a bonded state prediction system, a bonded state prediction method, a bonded state prediction program, and a method for producing a bonded article.

### BACKGROUND ART

In recent years, in industry, not only creation of products and services that meet customer needs but also achievement of SDGs (sustainable development goals) is also an increasingly important development motivation for corporate activities.

For example, paragraph 9-4 in the SDGs states, “Improve sustainability through improved infrastructure and industrial improvements by increasing the efficiency of resource use and expanding the adoption of clean technologies and environmentally friendly technologies and industrial processes.” Thus, there is an increasing need for technology to reduce losses in production processes, improve product yields, and, ultimately, detect product defects in upstream processes.

Such a demand for SDGs is expected to be realized through DX2 (Digital Transformation) and Society 5.0 (a new super-smart society brought about by Connected Industries in which various things and candies are connected). For that purpose, it is required to provide an algorithm for determination and sorting at a high speed and efficiently as data in a processable form and apply it to a process.

In particular, one of the causes of lowering the yield of various industrial products is the bonding process. This is because, in general, a defective product generated in the bonding process cannot be returned to an original member or product and needs to be disposed of. For example, in the mobile industry such as automobiles and aircraft, weight reduction for the purpose of reducing the amount of fossil fuel used, i.e., transition from metal to carbon reinforced fibers, and transition from metal bolts to adhesives are required, and further, in lithium ion batteries and the like, which are the key to electric vehicles with a low environmental load, higher durability, that is, highly accurate prediction of adhesive strength is required from the viewpoint of ensuring safety. Further, in the electronic industry and the display industry in which various new materials and expensive members appear, the importance of the problems has been increasing because the product development cycle is short and the products are used by a very large number of people.

For example, in recent years, as a change point in the display industry, new problems such as deterioration and delamination at the time of folding have occurred with a change in form factor such as foldability. Therefore, a more efficient development method than ever is required. These electronic devices usually have a laminated structure in which a plurality of layers are laminated, and an adhesion technology between adjacent layers is very important.

At present, in order to determine the bonded state, sampling from the production process and a destructive test are required. In a case where trial production is performed in a test plant for the purpose of optimization of prescription, issue presentation, or the like, conventionally, in order to confirm performance, there has been no other way but to inspect a finally completed sample by a destructive test. As described above, in a cycle in which after the inspection result of the finally completed sample is analyzed, feedback is applied and prototype producing is performed again, development efficiency is poor and it is not possible to keep up with the product development speed in the market. On the other hand, if a problem can be extracted in real time in a prototype process, for example, an optimum prescription can be quickly arrived at, which leads to efficiency in development.

On the other hand, as an inspection system, there is disclosed a system that visualizes a detection target and evaluates an adhesion amount and a film thickness by acquiring three dimensional information acquired by combining position information in a two dimensional space and spectral data corresponding to each position (for example, PTL 1). However, this system merely visualizes a state of the detection object, and does not predict in advance a failure (e.g., adhesion failure or curing failure) to occur in the detection object from the acquired information.

On the other hand, as a method of predicting the occurrence of adhesion failure in advance, a curing failure prediction method has been disclosed in which an altered part is detected by observing, in an uncured state, the optical properties of a bonding layer formed of a resin composition containing a synthetic resin that cures by ring-opening polymerization and a pH indicator whose optical properties change according to pH (e.g., PTL 2).

In addition, a method of estimating a cured state has been disclosed which includes a process of irradiating an ultraviolet curable resin containing a main agent and a photopolymerization initiator with ultraviolet rays, a process of detecting fluorescence emitted by the photopolymerization initiator upon receiving the ultraviolet rays, and a process of estimating the cured state of the ultraviolet curable resin based on the detected fluorescence (for example, PTL 3).

### CITATION LIST

### Patent Literatures

### PTL 1

Japanese Unexamined Patent Publication No. 2019-191130

### PTL 2

Japanese Unexamined Patent Publication No. 2020-94083

### PTL 3

Japanese Unexamined Patent Publication No. 2007-248244

### SUMMARY OF INVENTION

### Technical Problem

Incidentally, various factors are often involved in the occurrence of the abnormality of the bonded state. Therefore, it is difficult to predict the occurrence of an abnormality in the bonded state by capturing only one phenomenon. Therefore, it is desirable to capture the temporal change of two or more phenomena or specific phenomena, i.e., multidimensional data.

In addition, it is desired to analyze and predict the bonded state in accordance with an algorithm suitable for each material after acquiring the multidimensional data as described above.

In contrast, the methods of and of PTL 2 are merely limited technologies that can be applied only to a specific material (a synthetic resin that cures by ring-opening polymerization) for a specific cause (adhesion of salt). In addition, the data to be acquired was only data on fluorescence and was not multidimensional. The data relating to the fluorescence intensity and the temporal change thereof acquired in PTL 3 is local data and does not include position information in a two dimensional space. For this reason, it is not possible to predict the occurrence of an abnormality in the bonded state with high accuracy in either case. As described above, at present, there is no known method or system for predicting a bonded state with high accuracy, which can be applied to various bonding materials.

The present invention has been made in view of these circumstances, and an object thereof is to provide a bonded state prediction system that can be applied to various bonding materials and can predict a bonded state with high accuracy. Another object of the present invention is to provide a bonded state prediction method, a bonded state prediction program, and a method for producing a bonded article.

### Solution to Problem

A bonded state prediction system according to the present invention predicts a bonded state when an object having adhesiveness is bonded to an adherend, the bonded state prediction system including: a data acquirer that acquires two or more pieces of data including physical property value information on the two dimensional coordinates of the object; and a bonded state predictor that predicts a bonded state between the object and the adherend using the acquired two or more pieces of data.

A bonded state prediction method according to the present invention is a method of predicting a bonded state when an object having adhesiveness is bonded to an adherend, the bonded state prediction method including: acquiring two or more pieces of data including physical property value information on the two dimensional coordinates of the object; and predicting a bonded state between the object and the adherend using the acquired two or more pieces of data.

A bonded state prediction program according to the present invention is a program for predicting a bonded state when an object having adhesiveness is bonded to an adherend, wherein the program causes the computer to execute: acquiring two or more pieces of data including physical property value information on the two dimensional coordinates of the object; and predicting a bonded state between the object and the adherend using the acquired two or more pieces of data.

A method for producing a bonded article according to the present invention includes: predicting a bonded state between an object having adhesiveness and an adherend by performing the prediction method according to the present invention on the object; and adjusting processing condition for the object based on the predicted result.

### Advantageous Effects of Invention

According to the present invention, it is possible to provide a prediction system, a prediction method, and a prediction program for a bonded state, which can be applied to various bonding materials and can predict the bonded state with high accuracy, and a method for producing a bonded article using the same.

### DESCRIPTION OF EMBODIMENTS

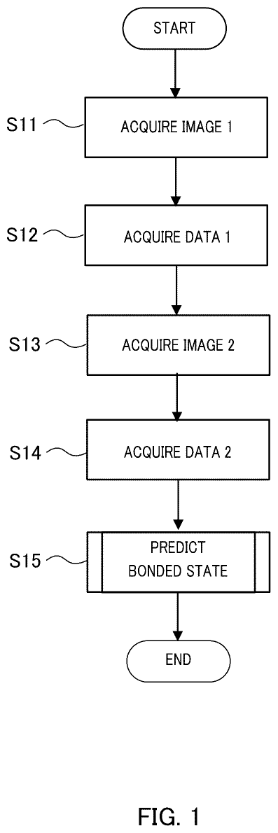

FIG. 1 is a flowchart illustrating an example of a bonded state prediction method according to an embodiment of the present invention;

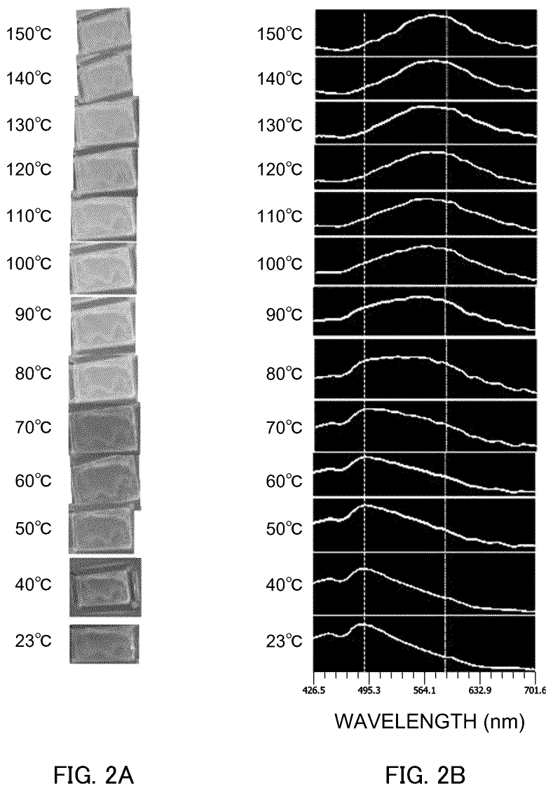

FIG. 2A illustrates an image captured by a normal camera for each temperature when the temperature of an object including a contrast agent (1) is changed, and FIG. 2B illustrates an optical spectrum acquired by averaging optical spectra of a specific area captured by a hyperspectral camera for each temperature;

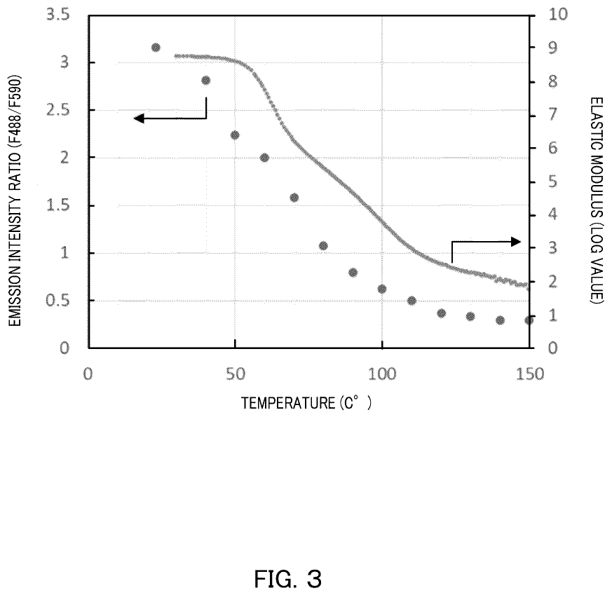

FIG. 3 is a graph illustrating the behavior of the ratio (F488/F590) of the emission intensities at wavelengths 488 nm and 590 nm acquired from the optical spectrum when the temperature of the object is changed, and the behavior of the elastic modulus (Log value) separately measured;

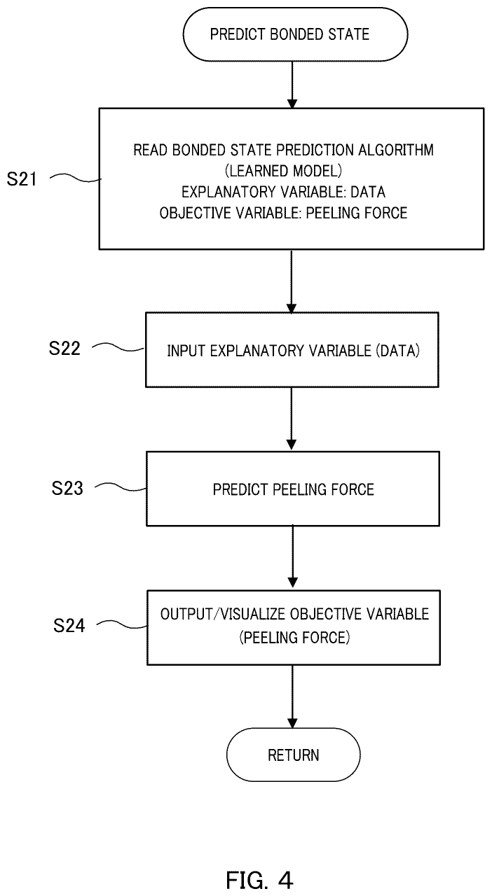

FIG. 4 is a flowchart illustrating an example of a prediction process;

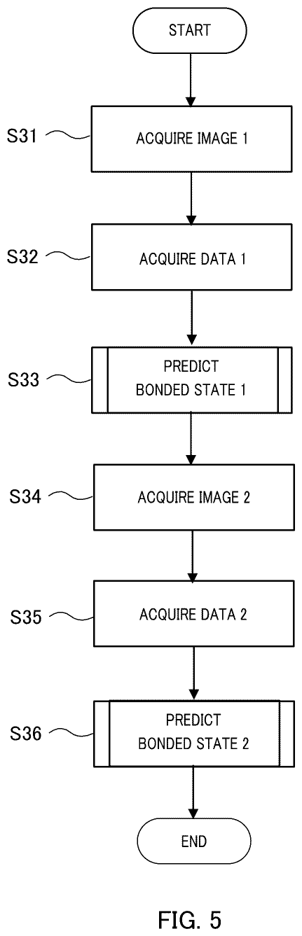

FIG. 5 is a flowchart illustrating a bonded state prediction method according to another embodiment of the present invention;

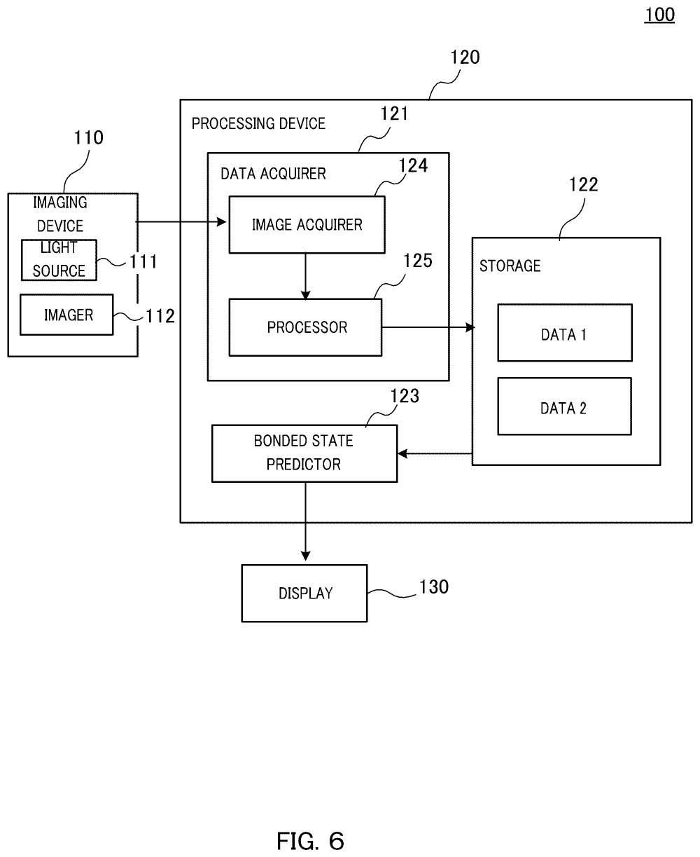

FIG. 6 is a schematic diagram illustrating an example of a configuration of a bonded state prediction system according to an embodiment of the present invention; and

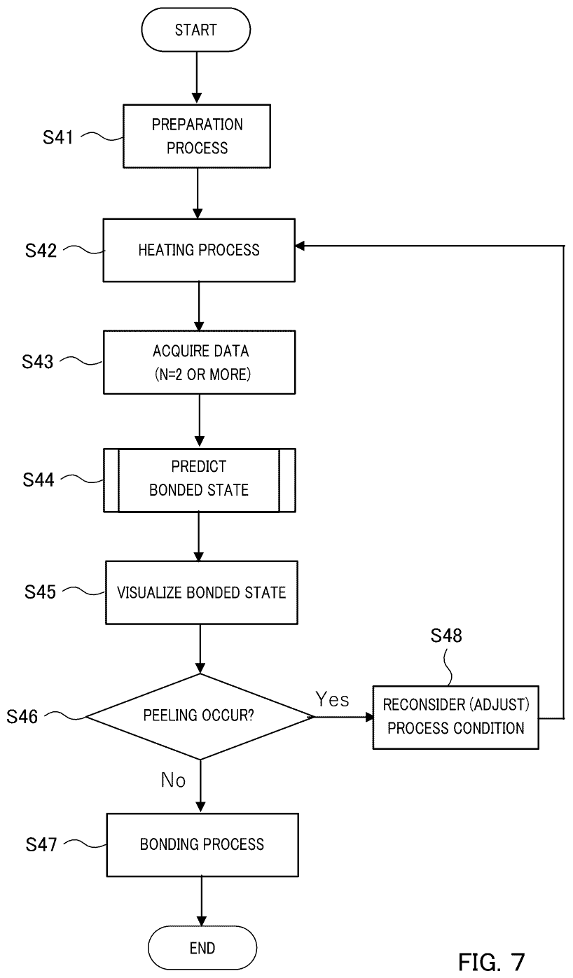

FIG. 7 is a flowchart illustrating an example of a method for producing a bonded article using the bonded state prediction method according to an embodiment of the present invention.

### DESCRIPTION OF EMBODIMENTS

Hereinafter, the present invention will be described in detail based on an embodiment of the. Note that the present invention is not limited to these embodiments.

### Bonded State Prediction Method

A bonded state prediction method according to an embodiment of the present invention will be described first, and then a prediction system that can be used for the prediction method will be described.

A bonded state prediction method according to an embodiment of the present invention is a bonded state prediction method when an object having adhesiveness is bonded to an adherend, for example, the quality of the final bonded state.

The object having adhesiveness is not particularly limited as long as it exhibits adhesiveness, and may be any of a thermocompression bonding material, an adhesive material, and a curable material. The thermocompression bonding material is a material that is melted and bonded with heat, and examples thereof include low-density polyethylene, an ethylene-vinyl acetate copolymer, and polypropylene. Examples of the adhesive material include acrylic, silicone, urethane, and rubber pressure-sensitive adhesives. Examples of the curable material include a light-curable material and a thermo-curable material. The material making up the adherend is also not particularly limited, and may be any of glass, a resin material, and a metal material.

FIG. 1 is a flowchart illustrating an example of a bonded state prediction method according to an embodiment of the present invention. As illustrated in FIG. 1, the bonded state prediction method according to the present embodiment includes an acquisition process of acquiring two or more pieces of information including physical property value information on two dimensional coordinates of an object (data acquisition process, steps S11 to S14), and a prediction process for a bonded state between the object and an adherend using the acquired two or more pieces of information (prediction process, step S15).

### Data Acquisition Process

In the data acquisition process, two or more pieces of data including physical property value information on two dimensional coordinates of the object are acquired.

“Data including physical property value information on two dimensional coordinates” (hereinafter, also simply referred to as “data” or “data including physical property value information”) is data including position information on two dimensional coordinates and physical property value information corresponding to each position, that is, two dimensional data of physical property value information.

The physical property value information refers to a physical property value of an object or information related thereto. The type of the physical property value information is not particularly limited as long as it relates to the prediction of the bonded state, and examples thereof include elastic modulus, degree of cure, hardness, film thickness, moisture content, residual solvent content, coating unevenness, temperature, viscosity, dynamic viscoelasticity (storage modulus, loss modulus), tan 8, surface tension, density, vapor pressure, boiling point, refractive index, cure shrinkage, glass transition temperature (Tg), SP value (polar component (dP), dispersion component (dD), hydrogen bonding component (dH)), molecular weight (number-average molecular weight Mn, weight-average molecular weight Mw, polydispersity Mw/Mn), molecular structure information (functional group, chemical bonded state, radical generation state), and the like. Among these, from the viewpoint of predicting the bonded state with higher accuracy, the physical property value information is preferably the elastic modulus, the degree of cure, the hardness, the coating unevenness, the polarity, the moisture content, the temperature, or the film thickness. Most of the physical property value information can be associated with the spectral characteristic information acquired from the optical spectrum data. Therefore, it is preferable that least one of the two or more pieces of data includes spectral characteristic information.

Data including such physical property value information can be acquired by acquiring two dimensional coordinate information of the object and associating the data with the acquired two dimensional coordinate information. Two dimensional coordinate information and the physical property value information may be acquired separately or simultaneously. When it is acquired simultaneously, it can be acquired directly or indirectly from the two dimensional image. Examples of the two dimensional image include a spectral image (a multispectral image or a hyperspectral image), a reflectance distribution image, and a temperature distribution image.

Two or more pieces of data may be data including predetermined physical property value information acquired over time, or may be data of physical property value information acquired for two or more different types. The data acquired over time may be acquired intermittently or continuously. The data of physical property value information acquired for two or more different types may be acquired simultaneously, or may be acquired at different timings.

At least one of the two or more pieces of data preferably includes the spectral characteristic information of the object, as described above. The spectral characteristic information may be an emission intensity at a specific wavelength acquired from the optical spectrum data, a ratio of the emission intensities, a peak shift, a reflectance, or the like. These pieces of spectral characteristic information are preferably associated with one or more selected from the group consisting of the elastic modulus, the degree of cure, the hardness, the polarity, and the moisture content.

Data including such spectral characteristic information can be acquired from the state of light reflected and emitted from an object when the object is irradiated with light having a predetermined wavelength. As described above, the data including the spectral characteristic information may be acquired separately by linking the two dimensional coordinate information and the information on the light reflected and emitted from the object corresponding thereto, or may be acquired simultaneously as a spectral image. The spectral image can be acquired by a means such as a hyperspectral camera capable of detecting light reflected and emitted from the object. In that case, it is preferable that the light emission behavior of the object changes in accordance with the state of the object. The “state of the object” means one piece of physical property value information of the object. In addition, “the light emission behavior changes” means that any one or more of the peak wavelength, the intensity, the spectrum, the fluorescence lifetime, the phosphorescence lifetime, and the like of the light reflected and emitted by the object change. The light emitted by the object may be light emitted by the object itself, or may be fluorescence or phosphorescence generated through excitation of a light emitting substance included in the object. Here, a substance which is an absorptive/luminescent substance contained in an object and whose absorptive/luminescent behavior (wavelength and intensity) changes in accordance with the state of the object is particularly referred to as a “contrast agent”.

That is, the object preferably contains a contrast agent. The contrast agent may be originally contained in the object, or may be artificially added later. When the contrast agent is fluorescent or phosphorescent, it is required to be excited by a known means in order to emit light, but the means is not limited, and light excitation, electric current excitation, chemical excitation, thermal excitation and the like can be used. The contrast agent is preferably a material that is excited to emit light by being irradiated with light having a predetermined wavelength, and more preferably a material that is excited to emit fluorescence by being irradiated with light having a predetermined wavelength.

As the contrast agent whose light emission behavior changes in accordance with the state of the object, a known chromic dye can be generally used as long as the chromic dye responds to the state to be observed. Examples of the chromic dye include, but note limited to, photochromic dyes described in Adv. Mater., 2013, 25, p378, Japanese Unexamined Patent Publication No. 2012-172139, Japanese Unexamined Patent Publication No. 2019-38973, and the like; solvatochromic dyes described in Acc Chem. Res., 2017, 50, p366, Japanese Unexamined Patent Publication No. 2008-291210, WO2020/171199, and the like; thermochromic dyes described in Japanese Unexamined Patent Publication No. 2019-31606, Japanese Translation of PCT International Publication 2015-533892, and the like; electrochromic dyes described in Chem Soc. Rev., 1997, 26, p147, WO2008/007563, Japanese Unexamined Patent Publication No. 2011-227462 and the like; piezochromic dyes described in Chem Eur. J, 2012, 18, p4558, Japanese Translation of PCT International Publication 2014-517711, Chem Sci., 2020, 11, p7525, and the like. Furthermore, the amount of the contrast agent to be added may be any amount that does not affect the adhesiveness and other required performances and that allows detection of the state of adhesiveness, but is preferably 10 ppm to 1.0 wt %, more preferably 50 ppm to 0.5 wt %, still more preferably 100 ppm to 0.1 wt %.

As the contrast agent, a compound whose light emission behavior changes in accordance with the hardness of an object or a compound whose light emission behavior changes in accordance with the moisture content in an object, polarity, or the like will be described as an example.

An example of the compound whose emission behavior changes in accordance with the hardness of an object includes a phenazine compound, such as the contrast agent (1). It is known that when this compound is brought into an excited state by light, the compound emits light at different wavelengths via two or more excited states depending on whether or not the environment around the compound itself is an “environment in which structural relaxation is likely to occur”. The “environment in which structural relaxation is likely to occur” as used herein comprehensively represents any one or more of the following: a sufficient free volume is present around the contrast agent itself so that the contrast agent is easily moved; thermal energy sufficient to facilitate molecular motion is acquired; the surrounding viscosity is low; and the surrounding is not solid but liquid. A state in which the free volume is small and the viscosity is high can be rephrased as a state in which the elastic modulus is high and the degree of cure is high in terms of resin. That is, by observing the emission wavelength of the contrast agent (1), the hardness of the object, which is typified by the elastic modulus and the degree of cure, can be acquired. The structure of such a contrast agent for visualizing hardness is not particularly limited as long as it is a compound capable of emitting light from two or more different excited states depending on the surrounding environment.

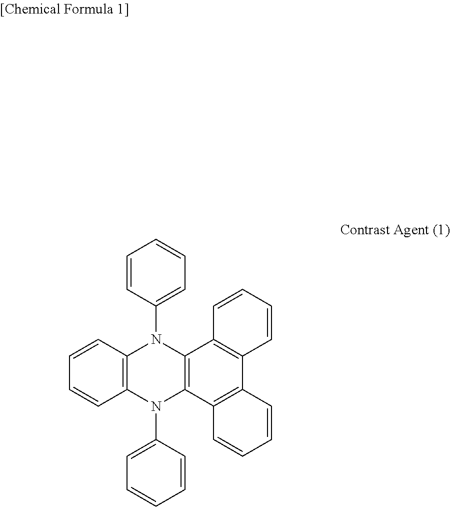 [SMILES: c1ccc(N2c3ccccc3N(c3ccccc3)c3c2c2ccccc2c2ccccc32)cc1]

Such dyes can be synthesized with reference to the above-mentioned Chem. Sci., 2020, 11, p7525.

In an environment in which the structure of the contrast agent (1) is less likely to be relaxed, that is, when the elastic modulus of the object is high, the peak of the emission intensity is near the wavelength 488 nm. On the other hand, in an environment in which structural relaxation is likely to occur, that is, when the elastic modulus of the object is low, the peak of the emission intensity is near the wavelength 590 nm. Therefore, the ratio (F488/F590) of the emission intensity (F488) at the wavelengths 488 nm and the emission intensity (F590) at the wavelengths 590 nm changes in accordance with the elastic modulus of the object. That is, the ratio (F488/F590) of the emission intensity (F590) as the spectral characteristic information can be associated with the elastic modulus.

The method of associating the ratio of emission intensity with the elastic modulus will be described in more detail.

FIG. 2A illustrates an image captured with a normal camera at respective temperatures when the temperature of an object including the contrast agent (1) is changed, and FIG. 2B illustrates an optical spectrum acquired by averaging optical spectra of a specific area captured with a hyperspectral camera at each temperature. In FIG. 2B, the horizontal axis represents wavelength (nm), and the vertical axis represents emission intensity (-). FIG. 3 is a graph illustrating the behavior of the ratio (F488/F590) of the emission intensities at wavelengths 488 nm and 590 nm acquired from the optical spectrum when the temperature of the object is changed, and the behavior of the elastic modulus (Log value) separately measured. In FIG. 3, the horizontal axis represents the temperature (° C.) of the object, the left vertical axis represents the emission intensity ratio (F488/F590), and the right vertical axis represents the Log value of the elastic modulus.

FIG. 2A illustrates how the emission color changes from blue (around 23 to 70° C.), to pink (80 to 110° C.), and to orange (120 to 150° C.) as the temperature increases. It can be seen from FIG. 2B that as the temperature increases, the peak of the emission intensity shifts to the long wavelength side. That is, it is shown that as the temperature increases, the proportion of long-wavelength components (red light emission components) with respect to short-wavelength components (blue light emission components) increases, that is, the ratio (F488/F590) of the emission intensity at the wavelengths 488 nm with respect to the emission intensity at the wavelengths 590 nm decreases (see FIG. 3). Further, it is shown that that the temperature change behavior of the emission intensity ratio is substantially the same as (corresponds to) the temperature change behavior of the actually measured elastic modulus. Therefore, the ratio of emission intensity can be associated with the elastic modulus. By performing this operation for each pixel on the two dimensional coordinates, the two dimensional data of the emission intensity ratio and the two dimensional data of the elastic modulus can be associated with each other. Thus, the two dimensional data of the emission intensity ratio can be used as data associated with the elastic modulus in the prediction process described later.

An example of the compound whose light emission behavior changes in accordance with the moisture content or the polarity in an object includes a solvatochromic dye. The solvatochromic dye is a dye whose emission wavelength or absorption wavelength changes depending on the moisture content or polarity of a surrounding object or solvent. This is understood as follows: depending on the type and composition of the solvent, the structure of the excited state of the dye is stabilized or destabilized, and thus the energy difference from the ground state changes, and as a result, the emission wavelength corresponding to that energy difference changes. That is, this means that by observing the emission wavelength, it is possible to indirectly visualize the type or composition of the surrounding object or solvent that stabilizes or destabilizes the contrast agent.

The structure of such a contrast agent for visualizing the moisture content or the polarity is not particularly limited as long as it is a dye whose emission wavelength or absorption wavelength changes depending on the moisture content or the polarity of a surrounding object or solvent. Examples of such contrast agents include, for example, squarylium dyes such as contrast agent (2).

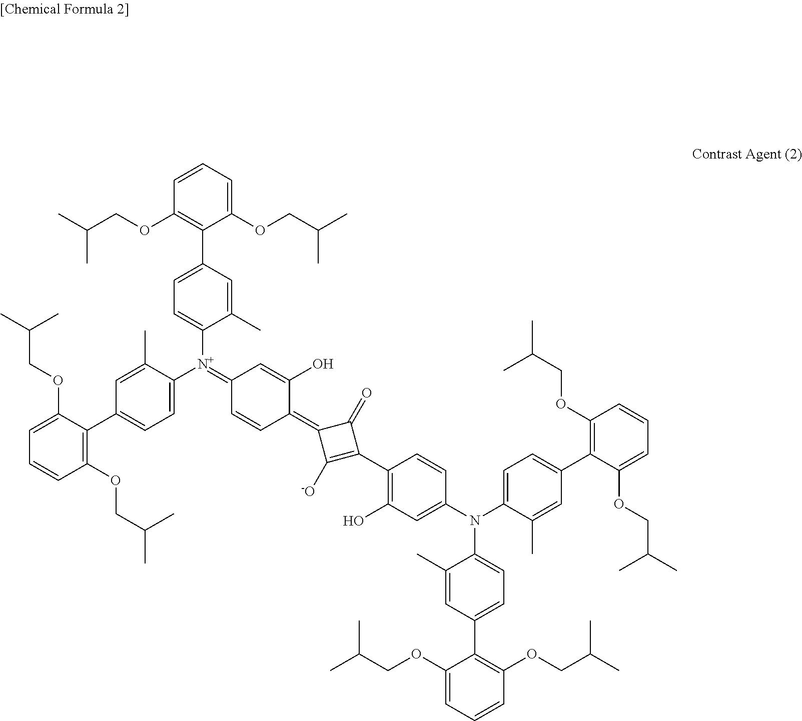

Such a dye can be synthesized with reference to the above-mentioned WO2020/171199.

The wavelength of the light (excitation light) with which the object is irradiated is appropriately selected according to the type of the contrast agent, the type of the object, and the like. For example, when the contrast agent is a compound that can be excited by visible light, the visible light is used as the excitation light. On the other hand, when the contrast agent is a compound that can be excited by ultraviolet light, ultraviolet light is used as the excitation light.

Another of the two or more pieces of data preferably includes film thickness information. This is because these data are closely related to the bonded state regardless of the type of the object and the adhesion method.

In the present embodiment, as illustrated in FIG. 1, for example, an image (image 1) is acquired by a hyperspectral camera under irradiation with light having predetermined wavelengths (step S11). Next, data (data 1) including the ratio (F488/F590) of the emission intensity associated with the elasticity modulus is acquired from the image (step S12).

Further, a reflection spectrum image (image 2) is acquired by the reflection spectroscopic film thickness meter (step S13). Then, data (data 2) including the film thickness is acquired from the reflection spectrum image (step S14).

### Prediction Process

In the prediction process (step S15), the two or more pieces of information acquired in the data acquisition process (steps S11 to S14) are used to analyze and predict the bonded state between the object and the bonded body. Performing such analysis and prediction on two or more pieces of data rather than using a single piece of data can increase the accuracy of the analysis and prediction.

The analysis and prediction of the bonded state can be performed by any method. For example, the bonded state of the object may be analyzed and predicted by comparing two or more pieces of data acquired over time for predetermined physical property value information.

In addition, data of the object in a standard state (e.g., a good bonded state) and data of the object in a predetermined state (e.g., a poor bonded state that causes peeling) may be acquired in advance, and the analysis and prediction of the bonded state of the object may be performed by comparing these data with the data acquired in the data acquisition process. The predetermined state may be set when the bonded state is good or when an adhesion failure occurs.

The analysis and prediction of the bonded state may be performed based on a prediction model (learned model) or the like generated in advance by machine learning. When the analysis is performed based on the learned model, it is possible to determine (predict) the bonded state of the object from the accumulated data or the like by applying two or more pieces of data acquired in the data acquisition process to the learned model.

FIG. 4 is a flowchart illustrating an example of a prediction process for a bonded state (step S15 in FIG. 1).

In the machine learning, for example, a process similar to the data acquisition process is performed a plurality of times. Then, based on this, a plurality of prediction models are constructed. Next, the results of the plurality of prediction models are combined to create a learned model (adhesion prediction state algorithm) capable of predicting information on the bonded state of the object (e.g., peeling force).

The prediction model can be constructed by performing machine learning in which two or more pieces of data are explanatory variables and a physical property (e.g., peeling force) indicating the bonded state of the object is an objective variable, for example, in a case where the state of the object is known in advance. Explanatory variables similar to those acquired in the data acquisition process (S11 to S14) can be used. The objective variable can be appropriately selected in accordance with the purpose of the analysis, and a variable related to the bonded state of the object (for example, a peeling force, a cross-cut test, a pencil hardness test, or the like) can be used.

The machine learning may be supervised learning or may be unsupervised learning. Note that supervised learning refers to a learning method of learning a “relationship between an input and an output” from learning data with a correct label. Unsupervised learning is a learning method of learning a “structure of a data group” from learning data without a correct label.

Furthermore, the machine learning may be reinforcement learning, deep learning, or deep reinforcement learning. Note that reinforcement learning refers to a learning method of learning an “optimal action sequence” by trial and error. The deep learning refers to a learning method of learning, from a large amount of data, features included in the data step by step more deeply (in deeper layers). The deep reinforcement learning refers to a learning method in which reinforcement learning and deep learning are combined.

A general analysis method (algorithm) can be applied to the machine learning. For the machine learning, for example, a prediction model constructed by an analysis method selected from linear regression (multiple regression analysis, partial least squares (PLS) regression, LASSO regression, Ridge regression, principal component regression (PCR), and the like), random forest, decision tree, support vector machine (SVM), support vector regression (SVR), neural network, discriminant analysis, and the like can be applied.

In the prediction process for the bonded state, the bonded state is analyzed and predicted using the created learned model. First, a learned model is read (step S21). In the present embodiment, for example, a learning model of a regression equation is read. The explanatory variables of the regression equation are two or more pieces of data acquired in the data acquisition process, and the objective variable is the peeling force.

Next, two or more pieces of data (for example, data including a ratio of emission intensities and data including a film thickness) to be input as explanatory variables are extracted from the data group acquired in the data acquisition process. Then, the extracted data is input, for each pixel, to the explanatory variable of the regression equation of the learned model (step S22). Next, the peeling force is predicted for each pixel (step S23), and is output as an objective variable (step S24). This is performed for each of the two or more pieces of data.

Next, the output peeling force for each pixel is plotted on two dimensional coordinates (step S24). Then, it is divided into areas according to the level of the peeling force, and each area is color-coded and visualized on a two dimensional coordinate. For example, an area where the peeling force exceeds a predetermined threshold value is defined as an NG area (area where adhesion failure occurs), and an area where the peeling force does not exceed the threshold value is defined as an OK area (area where adhesion failure does not occur), and these areas are color-coded and displayed. As a result, it is possible to visualize and predict, on the two dimensional coordinates, at which part of the object the adhesion failure occurs.

Note that in a case where it is difficult to determine a threshold value and clarify a boundary, it is preferable to perform contour clarification on the acquired image using a histograms of oriented gradients (HOG) feature amount. The “HOG feature amount” is a feature amount acquired by converting a local image gradient into a histogram. By acquiring the HOG feature amount, it is possible to detect the gradient of the peeling force and clarify the contour thereof. The HOG feature amount can be calculated with reference to various known papers, Japanese Unexamined Patent Publication No. 2018-36689, and the like. The above-described machine learning method can also be used for the boundary clarification algorithm.

Note that in a case where the peeling force of the object is actually measured separately from the prediction process S15, a result of actually measuring the peeling force is collated with the prediction result. Then, the collation result is added to the teacher data of the learned model. Thus, the prediction accuracy of the learned model can be further increased.

### Effects

Conventionally, single data has been acquired, and the bonded state of the object has been predicted from the acquired data. Therefore, the prediction accuracy has not been sufficient.

In contrast, in the present embodiment, two or more pieces of data are acquired, and the bonded state of the object is predicted using the acquired two or more pieces of data. As a result, compared to the related art, it is possible to perform multi-dimensional analysis and thus it is possible to increase prediction accuracy.

In addition, preferably, at least one of the two or more pieces of data is data including spectral characteristic information (for example, a ratio of emission intensity), and thus it is possible to acquire data necessary for predicting the bonded state in a non-contact manner and in real time. Furthermore, preferably, the prediction process is performed using the learned model, and thus the prediction of the bonded state can be performed with higher accuracy.

Note that in the above-described embodiment, two or more datasets are acquired in the data acquisition process (steps S11 to S14) and then the two or more datasets are used to predict the bonded state in the prediction process (step S15), but the present invention is not limited thereto, and the prediction process may be performed every time one or two or more datasets are acquired.

FIG. 5 is a flowchart illustrating a bonded state prediction method according to another embodiment of the present invention. In FIG. 5, a spectral image (image 1) is acquired (step S31), and data (data 1) including a ratio (F488/F590) of emission intensity associated with an elastic modulus is acquired therefrom (step S32). Then, the bonded state prediction process (step S33) is performed using the acquired data. Next, a reflection spectrum image (image 2) is acquired (step S34), and data (data 2) including a thickness is acquired therefrom (step S35). Then, the bonded state prediction process (step S36) is performed using the acquired data. In this way, the prediction process may be performed each time one or more pieces of data are acquired.

Note that steps S31, S32, S34, and S35 in FIG. 5 correspond to steps S11, S12, S13, and S14 in FIG. 1, respectively. The combination of steps S33 and S36 in FIG. 5 corresponds to step S15 in FIG. 1.

Furthermore, although data including the ratio of emission intensities or the elastic modulus and data including the film thickness are acquired as the two or more pieces of data in the above-described embodiment, it is not limited thereto, and appropriate data may be acquired according to the type of the object, the type of the adherend, and the adhesion method.

### 2. Bonded State Prediction System

The bonded state prediction method according to the present embodiment can be performed by the following bonded state prediction system. Note that the system for performing the bonded state prediction method is not limited to the following system.

FIG. 6 is a schematic diagram illustrating a configuration of a bonded state prediction system 100 according to the present embodiment. As illustrated in FIG. 6, the prediction system 100 according to the present embodiment includes an imaging device 110, a processing device 120, and a display 130.

### Imaging Device

The imaging device 110 captures an image indicating a light emission state of the object when the object is irradiated with light. The imaging device 110 includes a light source 111 and an imager 112.

The light source 111 is not particularly limited as long as it is a means capable of irradiating an object with light having a predetermined wavelength. As the light source 111, lamps in a wide wavelength range are applicable, and examples thereof include light sources in the ultraviolet, visible, near-infrared, and infrared regions. For example, xenon lamps, halogen lamps, white LED lamps, near infrared hyperspectral imaging illumination (LDL-222X42CIR-LACL manufactured by CCS Inc., etc), laser-excited white light sources capable of emitting light from deep ultraviolet to near infrared wavelengths (XWS-65 manufactured by KLV Co., Ltd., etc), and the like can be used. A light source including an ultraviolet region is preferable in a case of using a fluorescence emitting material, and a light source including infrared light is preferable in a case of using an infrared dye or the like. In addition, when a specific material such as a contrast agent is excited to emit light, a light source having a sharp waveform such as an LED light source is preferable because a spectrum unique to the contrast agent can be emphasized. Note that the shape of the light sources may be that of normal point light sources, but in the case of installation on a production line or the like, it is preferable to use line illumination (high-brightness condenser type line illumination, LDL-222X42CIR-LACL, etc., manufactured by CCS Inc).

The imager 112 is not particularly limited as long as it is a means capable of receiving the light from the light source 111 and imaging the state of the light reflected or emitted by the object, and is appropriately selected according to the type of data to be acquired. For example, the imaging device 110 may be a monochrome camera, a color camera, an infrared camera, a multispectral camera, a hyperspectral camera, or the like. The image captured by the imaging device 110 is output to the data acquirer 121. Note that the multispectral camera and the hyperspectral camera are cameras capable of capturing images at more wavelengths than a normal camera and are cameras having high spectral resolution and spatial resolution, and therefore are preferable because an object can be quantitatively evaluated at multiple points in a wide range by one measurement. The wavelength-resolving power is preferably 50 nm or less, more preferably 10 nm or less, still more preferably 5 nm or less. However, if the resolution is increased more than necessary, the amount of data processing increases, which increases the load on the data processor and the processing time, and therefore, it is preferable to set the resolution to the minimum necessary resolution. In addition, there are an area type (snapshot type) and a line type in the multispectral camera and the hyperspectral camera, and the area type is preferable when observing a member/individual form, and the line type is preferable when observing a roll shape. Examples of the hyperspectral camera capable of measuring the visible light region include, but not limited to, m the SpecimIQ available from Specim, FX-10, NH series available from Eva Japan Co., Ltd. Examples of the hyperspectral camera capable of measuring a near-infrared region include, but not limited to, m FX-17 available from Specim Inc., SW-IR, PikaNIR-320 available from Resonon, SWIR-640 available from HySpex, SNAPSHOTT-SWIR available from Imec, SIS-IR series and SIS-SWIR series available from Eva Japan Co., Ltd. Examples of the hyperspectral camera capable of measuring a mid-infrared region include, but not limited to, m FX-50 available from Specim Inc., MW-IR and the like. Examples of the hyperspectral camera capable of measuring a far infrared region include, but not limited to, m LW-IR available from Imec Specim Inc. and the like.

### Processing Device

The processing device 120 includes the data acquirer 121 that acquires two or more pieces of data on the object from the image, a storage 122 that stores the acquired two or more pieces of data, and a bonded state predictor 123 that predicts the bonded state between the object and the adherend using the acquired two or more pieces of data.

The data acquirer 121 performs the above-described data acquisition process. That is, two dimensional coordinate information and physical property value information linked thereto are acquired. In the present embodiment, the data acquirer 121 includes an image acquirer 124 that acquires an image captured by the imaging device 110, and a processor 125 that acquires two or more pieces of the above-described data (data including physical property value information on two dimensional coordinates) from the image.

The image acquirer 124 may be any means capable of acquiring an image captured by the imaging device 110 or an image captured by an external device (not illustrated).

The processor 125 may be any means capable of acquiring data on the object from the image acquired by the image acquirer 124. For example, the processor 125 may acquire a ratio of emission intensity (F488/F590) from the spectral image acquired by the image acquirer 124. Note that depending on the type of the image to be acquired by the image acquirer 124, the processor 125 may be unnecessary or the processing of the processor 125 may not be performed. For example, since temperature information is directly acquired from a temperature distribution image acquired by infrared thermography, processing by the processor 125 is unnecessary. In addition, since film thickness information is directly acquired from reflection spectrum data acquired by the reflection spectroscopic film thickness meter, processing by the processor 125 is unnecessary.

The storage 122 may be any means capable of storing two or more pieces of data acquired by the processor 125.

The bonded state predictor 123 performs the prediction process. The bonded state predictor 123 may be any means capable of analyzing the data acquired by the data acquirer 121 (e.g., the processor 125). For example, data including separately acquired physical property value information for reference may be read, and the data for reference and data acquired from the data acquirer 121 (for example, the processor 125) may be compared to analyze and predict the bonded state. The bonded state predictor 123 may predict the bonded state on the basis of the learned model. Specifically, the bonded state predictor 123 may read a learned model from the storage 122 or an external storage device (not illustrated), and perform calculation by inputting data acquired by the data acquirer 121 (for example, the processor 125) to the learned model. Next, the calculation result, that is, the prediction result of the bonded state is output.

As the processing device 120, a general computer (general-purpose computer) including a storage means such as a hard disk drive (HDD), a solid state drive (SSD), or a read-only memory (ROM) that stores a program, data, or the like, and a central processor (CPU) that executes a program, performs calculation processing, or the like can be used. The computer may further include input means such as a keyboard and a mouse, and output means such as a monitor and a printer.

### Display

The display 130 may be any means capable of displaying the result predicted by the bonded state predictor 123. The display 130 can be an output unit such as a monitor or a printer. The display 130 may be configured integrally with the processing device 120.

### Effects

As described above, the prediction system 100 according to the present embodiment includes the data acquirer 121 that acquires two or more pieces of data on an object and the bonded state predictor 123 that predicts the bonded state of the object using the acquired two or more pieces of data. As a result, compared to the related art, it is possible to perform multi-dimensional analysis and thus it is possible to increase prediction accuracy.

In the above-described embodiment, the prediction system 100 includes the imaging device 110, but may not include the imaging device 110. For example, the prediction system 100 may be configured such that the image acquirer 124 reads an image indicating a light emission state separately acquired by an external imaging device (not illustrated).

Although the above-described embodiment illustrates the example in which the data acquirer includes the image acquirer 124 that acquires the two dimensional coordinate information and the physical property value information at the same time, it is not limited thereto, and it may be a two dimensional coordinate information acquirer that acquires the two dimensional coordinate information and the physical property value information associated therewith separately.

In addition, in the above-described embodiment, the prediction system 100 includes the storage 122, but may not include the storage 122. For example, the prediction system 100 may be configured such that two or more pieces of data acquired by the processor 125 can be directly input from the processor 125 to the bonded state predictor 123, or may be configured such that two or more pieces of data can be read from an external storage device (not illustrated).

In the above-described embodiment, the prediction system 100 includes the display 130. However, the prediction system 100 may not include the display 130, and a result output from the bonded state predictor 123 may be displayed on an external display device (not illustrated).

### 3. Bonded State Prediction Program

The bonded state prediction method according to the present embodiment can be performed by the following bonded state prediction program.

That is, the bonded state prediction program according to the present embodiment is a bonded state prediction program, which causes a computer to execute the above data acquisition process (e.g., steps S11 to S14 in FIG. 1) and the prediction process for the bonded state (e.g., step S15 in FIG. 1). The content of each process of the prediction program is the same as the content of each process of the prediction method.

The prediction program may be provided by being stored in a recording medium such as a DVD or a USB memory, or may be stored in a server device on a network so as to be downloadable via the network.

### 4. Method for Producing Bonded Article

### Embodiment 1

The bonded state prediction method can be applied to production processes of various devices and members thereof. Examples of the device and the member thereof include a display, a polarizing plate, a touch panel, and an optical film. The bonded state prediction method can be applied to, for example, a process of bonding two adherends via a thermocompression bonding film in a method for producing a device.

FIG. 7 is a flowchart illustrating an example of a method of producing a bonded article according to the present embodiment. As illustrated in FIG. 7, first, a process of preparing a thermocompression bonding film (object) (preparation process, step S41) and a thermocompression bonding film is melted by heating treatment (heating process, step S42). Next, data including physical property value information of the heated and melted thermocompression bonding film is acquired (step S43), and the bonded state of the interface between the thermocompression bonding film and the glass film when the heated and melted thermocompression bonding film is bonded to the glass film (adherend) is predicted (a bonded state prediction process, step S44). Then, the prediction result of the bonded state is visualized (visualization process, step S45), and it is determined whether or not peeling occurs (determination process, step S46). If it is determined that delamination does not occur, the glass substrate is bonded to a glass film to acquire a bonded article (a bonding process, Step S47). On the other hand, if it is determined that peeling will occur, the heating processing conditions are reviewed (adjustment process, step S48), and the heating process is performed again (heating process, step S42). Hereinafter, each step will be described.

### 1) Preparation Process (Step S41).

First, a thermocompression bonding film is prepared. The thermocompression bonding film may be prepared by applying a thermocompression bonding material onto a base material such as a resin film, or a thermocompression bonding material may be applied onto a base material in advance. A method of applying the thermocompression bonding material onto the base material is not particularly limited, and may be a coating method or a melt extrusion method. Further, in the present embodiment, a resin film is used as the base material, but another base material may be used depending on the application.

In the present embodiment, the thermocompression bonding film preferably contains a contrast agent (e.g., the above-described contrast agent (1) or excitation wavelength 365 nm) suitable for acquisition of data including elastic modulus. The reason why it is preferable to include the contrast agent is that, in order that the thermocompression bonding film adheres to the adherend with sufficient adhesive force, it is a very important requirement that the fluidity at the time of heating and melting and the elastic modulus at the time of adhesion after cooling of the hot-melt adhesive material and the hot-melt bonding material used as the adhesive of the thermocompression bonding film are in appropriate ranges, and it is particularly effective information for predicting the bonded state.

### 2) Heating Process (Step S42).

Next, the thermocompression bonding film is subjected to heating. Thus, the thermocompression bonding film is heated and melted to be brought into an easily bondable state. The heating temperature can be, for example, in the vicinity of the glass transition temperature Tg of the thermocompression bonding film.

### 3) Bonded State Prediction Process (Steps S43 To S44

Next, the bonded state prediction method of the present invention is performed. In the present embodiment, the bonded state prediction method is performed by the procedure illustrated in FIG. 1.

More specifically, an image (image 1) indicating a light-emitting state when the heat-melted thermocompression bonding film is irradiated with light having an excitation wavelength 365 nm is acquired with a hyperspectral camera. Then, data (data 1) including the ratio (F488/F590) of the emission intensity associated with the elasticity modulus is acquired. The spectral image may be acquired a plurality of times over time. Further, reflection spectrum data (image 2) of the heat-melted thermocompression bonding film is acquired by a reflection spectroscopic film thickness meter, and data (data 2) including the film thickness is acquired. The reason why the data including the film thickness is acquired is that the film thickness of the adhesive layer is one of important factors determining the adhesive force. Even if the fluidity and the elastic modulus described above are within appropriate ranges, a sufficient adhesive force cannot be exhibited unless the film thickness is within an appropriate range. Therefore, the film thickness is also effective information for predicting the bonded state. Further, a temperature distribution image (image 3) of the heated and melted thermocompression bonding film is acquired by an infrared thermography, and temperature data (data 3) is acquired (step S43). The reason why the temperature data is acquired is as follows. For example, in a case where the fluidity of the adhesive visualized with the contrast agent (1) is not as expected, if the film thickness is as expected, it is considered that the reason is that the temperature is not sufficiently high, the temperature distribution is uneven, or the like. Therefore, the temperature is important information in understanding why the prediction result of the bonded state is so.

Next, using the acquired data 1, 2, and 3, the bonded state of the interface between the thermocompression bonding film and the glass film in the case where the glass films (adherends) are bonded to each other is predicted (step S44). For example, as illustrated in FIG. 4, the above data 1, 2, and 3 are input as explanatory variables of the learned model, and the peeling force is output as an objective variable. Specifically, the peeling force is output for each position on the two dimensional coordinates.

### 4) Visualization Process (Step S45).

Next, the result output in the bonded state prediction process is visualized. The visualization method is not particularly limited, but for example, a portion in which the peeling force exceeds a threshold value (peeling force NG area) and a portion in which the peeling force does not exceed the threshold value (peeling force OK area) are color-coded and displayed for each position on the two dimensional coordinates. This makes it possible to predict in advance the bonded state between the thermocompression bonding film and the glass film after the bonding process (including after the end of the durability test).

### 5) Determination Process (Step S46)

Then, based on the visualized data, it is determined whether peeling occurs. The determination method is not particularly limited, and for example, the determination can be performed by collating with already acquired data. Then, when it is determined in the determination process that peeling does not occur, the bonding process (Step S47) is performed. On the other hand, when it is determined that peeling occurs, the adjustment process (step S48) is performed.

### 6) Bonding Process (Step S47)

When it is determined that peeling does not occur in the determination process, a glass film is bonded to the heat-melted thermocompression bonding film. Thus, a bonded article of the thermocompression bonding film and the glass film (a bonded article in which the resin film and the glass film are bonded to each other through the thermocompression bonding material) can be acquired.

### 7) Adjustment Process (Step S48).

When it is determined in the determination process that peeling occurs, the heat processing conditions in the heating process (Step S42) are adjusted. For example, the temperature and time for heating are set based on the distribution of the peeling force. Then, the process returns to the heating process (step S42), and the heating process is performed again under the conditions set in the adjustment process (step S42). This is repeated until the NG area of the peeling force is not detected in the determination process.

As described above, the method for producing a bonded article according to the present embodiment includes a process of applying the bonded state prediction method of the present invention to a thermocompression bonding film (object having adhesiveness) to predict a bonded state between the thermocompression bonding film and a glass film when the glass film (adherend) is bonded, and a process of adjusting processing conditions for the object on the basis of the prediction result. Thus, a bonded article can be produced by predicting the bonded state when glass films are bonded together, thereby enhancing production efficiency.

Note that in the above-described embodiment, an example has been described in which the bonded state prediction process (steps S43 to S44) is performed in accordance with the procedure illustrated in FIG. 1, but the present invention is not limited thereto, and it may be performed in accordance with the procedure illustrated in FIG. 5, for example.

Furthermore, in the above-described embodiment, the example in which the process of visualizing the result output in the bonded state prediction process (visualization process) is performed has been described, but the step may be performed as necessary or may not be performed.

Furthermore, although the state of adhesion between the thermocompression bonding film and the adherend is predicted in the above-described embodiment, it is not limited thereto. For example, the bonded state between the curable material or the adhesive material and the adherend may be predicted. Therefore, the heating process (step S42) of the above-described embodiment may be a process corresponding to the type of the object. For example, when the object is a light-curable material, the process may be a light irradiation process.

### Embodiment 2

The bonded state prediction method of the present invention may be applied to, for example, a process of forming an insulating protective layer such as a solder resist for circuit protection on a surface of a printed wiring board in a method for producing a wiring board such as a printed wiring board.

In the process of forming the solder resist, first, a light-curable material is applied and formed on the printed wiring board (a coating process). Next, the acquired coating film is cured by irradiation with light (a curing process). Thus, a solder resist containing a cured product of the light-curable material is formed on the surface of the printed wiring board.

The light-curable material usually contains a photocurable compound and a photopolymerization initiator. The photocurable compound is preferably a radically curable compound. In the present embodiment, the light-curable material preferably further contains a contrast agent suitable for acquisition of information including hardness (e.g., the above-described contrast agent (1); excitation wavelengths 365 nm) and a contrast agent suitable for acquisition of information including polarity (e.g., the above-described contrast agent (2); excitation wavelengths 660 nm). The reason why it is preferable to include the contrast agent (1) capable of visualizing the hardness is that the hardness is effective information for predicting the bonded state because the light-curable material is required to have a hardness in an appropriate range in order to maintain sufficient adhesiveness even in post-processes (a developing process, a soldering process, and the like). The contrast agent (1) is preferable because not only the hardness but also whether the degree of cure is in an appropriate range, that is, whether the curing reaction is completed can be visualized. The reason why it is preferable to include the contrast agent (2) capable of visualizing the polarity is that electronic physical properties such as polarity due to a functional group or the like of a monomer contained in the light-curable material is one of important factors affecting the adhesiveness to an adherend such as a printed wiring board.

Then, as illustrated in FIG. 1, a bonded state prediction method is performed.

More specifically, in the coating process, a spectral image (image 1) indicating a light emission state when the coating film is irradiated with light having an excitation wavelength 660 nm is acquired by the hyperspectral camera. Then, the ratio (F800/F750) of the emission intensity at the wave length F800 to the emission intensity at the wave length F750 (data 1) associated with the polarity can be acquired. In addition, in the curing process, a spectral image (image 2) indicating a light emission state when the coating film is irradiated with light having an excitation wavelength 365 nm is acquired by the hyperspectral camera. Then, information (information 2) including the ratio (F430 nm/F600) of the emission intensity at the wave length F600 to the emission intensity at the wave length 600 nm associated with the hardness is acquired.

Then, using the acquired data 1 and 2, the prediction process for the bonded state is performed at each timing after the coating process and after the curing process. Thus, the final (including after the durability test) cured product of the light-curable material, that is, the bonded state of the solder resist to the printed wiring board can be predicted in advance.

### Embodiment 3

The bonded state prediction method of the present invention may be applied to, for example, a method for producing a hard coat film. The hard coat film is used for, for example, a base material for a flexible display such as an organic EL display, a barrier film for preventing moisture permeation, or the like, and includes a light-transmitting resin film and a hard coat layer containing a cured product of a light-curable material.

In a production process of such a hard coat film, a light-curable material is applied and formed on a resin film (coating process). Next, the applied light-curable material is cured by irradiating it with light (a curing process). Thus, a hard coat layer containing a cured product of the light-curable material is formed.

In the present embodiment, the light-curable material can contain a photocurable compound and a photopolymerization initiator in the same manner as described above. The photocurable compound is preferably a radically curable compound. In the present embodiment, it is preferable that the light-curable material further include a contrast agent (e.g., the contrast agent (1) and the excitation wavelength 365 nm described above) suitable for acquiring data including the degree of cure.

Next, as illustrated in FIG. 5, a bonded state prediction method is performed.

More specifically, in the coating process, a spectral image (image 1) indicating a light emission state when the coating film is irradiated with light having an excitation wavelength 365 nm is acquired by the hyperspectral camera. Thus, data (data 1) including the emission intensity of the 600 nm of wavelengths associated with the application unevenness is acquired. That is, in order to bond the hard coat layer to the resin film with a sufficient adhesive force, it is a major premise that the hard coat layer is uniformly formed. Therefore, the first step of predicting the bonded state described later can be performed by visualizing, with the contrast agent (1), whether or not the application amount of the coating film and the distribution thereof are within appropriate ranges (whether or not the application unevenness is suppressed to a certain level or less), that is, whether or not the minimum requirements for adhesion are satisfied. If abnormal bonding can be predicted at an early stage in the process by dividing and executing the prediction of the bonded state for each step in this manner, this leads to a reduction in time and a reduction in loss, which is preferable.

In addition, in the curing process, a spectral image (image 2) indicating a light emission state when the coating film is irradiated with light having an excitation wavelength 365 nm is acquired by the hyperspectral camera. Thus, data (data 1) including the ratio of emission intensity (F430/F600) associated with the degree of cure is acquired. By visualizing, with the contrast agent (1), that the degree of cure is in an appropriate range, that is, the curing reaction is completed, the second step of predicting the bonded state described later can be performed. The second step enables more accurate prediction than the prediction of the first step.

Furthermore, in the curing process, reflection spectrum data (image 3) of the coating film is acquired with a reflection spectroscopic film thickness meter. Thus, data (data 3) including the film thickness is acquired. As described in the first embodiment, the film thickness information is an important factor in predicting the bonded state, and it is preferable to acquire the film thickness information in order to improve prediction accuracy.

Next, using the acquired data 1, the prediction process for the bonded state is performed after the coating process (bonded state prediction 1 in FIG. 5, step S33). Thus, the bonded state of the hard coat layer to the resin film after the coating process can be predicted. Furthermore, using the acquired data 2 and data 3, the prediction process for the bonded state is performed after the curing process (bonded state prediction 2 in FIG. 5, step S33). Thus, the final bonded state of the hard coat layer to the resin film can be predicted.

### Embodiment 4

The bonded state prediction method of the present invention can also be used for evaluation of an adhesive film in a method for producing an adhesive film, for example. Specifically, after an adhesive material is applied and formed on a resin film (base material) (coating process), the applied adhesive material is dried (drying process). Then, the acquired adhesive film is evaluated.

The adhesive material contains an adhesive as a main agent. In the present embodiment, the adhesive material preferably further contains a contrast agent suitable for acquisition of information including coating unevenness (e.g., the above-described contrast agent (1) and excitation wavelength 365 nm) and a contrast agent suitable for acquisition of information including the amount of residual solvents (e.g., the above-described contrast agent (2) and excitation wavelength 660 nm). That is, whether or not the adhesive material layer formed on the resin film is uniformly formed in an appropriate film thickness range is important for whether or not the adhesive material layer can exhibit a sufficient adhesive force to an adherend. Therefore, it is preferable to include the contrast agent (1) capable of visualizing coating unevenness and it is also preferable to acquire film thickness data. In addition, when the solvent remains in the film, it may be a factor that reduces the adhesive force, and therefore, it is preferable to include a contrast agent (2) that can visualize the amount of the residual solvent.

Then, as illustrated in FIG. 1, a bonded state prediction method is performed.

More specifically, in the coating process, a spectral image (image 1) indicating a light emission state when the coating film is irradiated with light having an excitation wavelength 365 nm is acquired by the hyperspectral camera. Thus, data (data 1) including the emission intensity of the 600 nm of wavelengths associated with the application unevenness is acquired. Furthermore, in the coating process, reflection spectrum data (image 2) of the coating film is acquired by a film thickness reflection spectrometer. Thus, data (data 2) including the film thickness is acquired. Furthermore, in the drying process, a spectral image (image 3) indicating a light emission state when the coating film is irradiated with light having an excitation wavelength 660 nm is acquired by a hyperspectral camera. Thus, data (data 3) including an emission peak shift (F750 to 800) associated with the amount of residual solvents is acquired.

Next, a prediction process for a bonded state in a case where the adhesive film is used in the bonding process is performed using the acquired data 1, data 2, and data 3 described above. This makes it possible to predict the bonded state of the adhesive material to the adherend after the bonding process.

### Embodiment 5

The bonded state prediction method of the present invention may be applied to, for example, a method for producing a polarizing plate. The polarizing plate includes a polarizer, a light-transmissive resin film, and a cured product of a light-curable material disposed therebetween.

In a production process of such a polarizing plate, for example, a process of applying and forming a light-curable material on a polarizer (coating process). Next, a light-transmitting resin film is bonded onto the applied light-curable material (a bonding process). Then, the bonded resin films are irradiated with light to cure the light-curable material (curing process). Thus, a polarizing plate can be produced.

As described above, the light-curable material contains a photocurable compound and a photopolymerization initiator. The photocurable compound is preferably a cationically curable compound. In the present embodiment, the light-curable material preferably further contains a contrast agent suitable for acquiring information including the degree of cure (e.g., the above-described contrast agent (1); excitation wavelengths 365 nm) and a contrast agent suitable for acquiring information including the moisture content (e.g., the above-described contrast agent (2); excitation wavelengths 660 nm). The reason why it is preferable to include the contrast agent (2) capable of visualizing the moisture content is that since moisture contained in the cationically curable compound may be a factor causing curing inhibition, it may be important information in understanding the cause of the case where the curing is insufficient. In addition, it is preferable to include the contrast agent (1) capable of visualizing the degree of cure, since it makes possible to determine whether or not the degree of cure is in an appropriate range, that is, the curing reaction is completed. The reason why the completion of the curing reaction at an appropriate level is visualized in this way is that if the curing is insufficient, a target adhesive force cannot be acquired, and thus the degree of cure is effective information for predicting the bonded state.

Then, as illustrated in FIG. 1, a bonded state prediction method is performed.

More specifically, in the curing process, a spectral image (image 1) indicating a light emission state when the coating film is irradiated with light having an excitation wavelength 365 nm is acquired by a hyperspectral camera. Next, data (data 1) including the ratio (F430/F600) of the emission intensity at 430 nm to the emission intensity at 600 nm associated with the degree of cure is acquired. Furthermore, a spectroscopic image (image 2) indicating the state of light emission when the cured product is irradiated with light at the excitation wavelength 660 nm in the bonding process is acquired with the hyperspectral camera. Then, data (data 2) including an emission peak shift (F750 to 800) associated with the moisture content is acquired.

Then, using the acquired data 1 and data 2, a prediction process for the bonded state is performed after the production of the polarizing plate and before the sampling inspection. Thus, the final bonded state of the polarizing plate (including the state after the durability test) can be predicted.

### Embodiment 6

In the bonded state prediction method of a solder resist to a printed wiring board described in embodiment 2, the bonded state can be predicted by acquiring near infrared reflection spectra (e.g., 1000 nm to 2700 nm) of the light-curable material before and after curing with a hyperspectral camera.

Then, as illustrated in FIG. 1, a bonded state prediction method is performed.

Specifically, in the coating process, a spectral image (image 1) indicating a near-infrared absorption spectrum when the coating film is irradiated with halogen lamp light as a light source is acquired by a hyperspectral camera. Then, data (data 1) associated with the molecular structure information of the light-curable material before curing is acquired. Subsequently, in the curing process, a spectral image (image 2) indicating a near-infrared absorption spectrum when the coating film is irradiated with halogen lamp light as a light source is acquired by a hyperspectral camera. Then, data (data 2) associated with molecular structure information of the light-curable material after curing is acquired. Infrared light is absorbed by vibration and rotational motion of molecules, and the energy thereof varies depending on the chemical structure. Therefore, when the infrared light is measured, information on the chemical structure and the state of molecules can be acquired. More specifically, data 1 and data 2 can be acquired as near infrared absorbance spectra (for example, absorbance of specific wavelengths in the range of wavelengths 1000 to 2700 nm) from the reflected lights acquired by the hyperspectral camera. Further, data 3 associated with the degree of cure can be acquired from a difference between data 1 and data 2, that is, (data 1)-(data 2). Data 3, which is the difference spectrum between the near-infrared absorption spectra before and after curing acquired in this way, reflects changes in the chemical structure and molecular state due to curing of the light-curable material, and can therefore be associated with the degree of cure.

With the data 1, 2, and 3 thus acquired, the cured product of the light-curable material, that is, the bonded state of the solder resist to the printed wiring board can be predicted in advance.

This application claims the benefit of Japanese Patent Application No. 2022-78942 filed on May 12, 2022. The contents described in the specification of the application and the drawings are incorporated herein by reference in their entirety.

### INDUSTRIAL APPLICABILITY

According to the present invention, it is possible to provide a bonded state prediction system and the like that can be applied to various bonding materials and can predict a bonded state with high accuracy. Thus, adhesion failure or the like can be detected in advance in real time in various production processes, thereby enhancing producing efficiency. In particular, the present invention is not only applicable to in-line failure detection (process control) in the production process and quality control of final products, but also effectively applicable to preliminary studies (laboratory studies, prototype studies, etc) such as material search and formulation studies, and processing condition studies.

### REFERENCE SIGNS LIST

100 Prediction system
110 Imaging device
111 Light source
112 Imager
120 Processing device
121 Data acquirer
122 Storage
123 Bonded state predictor
124 Image acquirer
125 Processor
130 Display

1. A bonded state prediction system that predicts a bonded state when an object having adhesiveness is bonded to an adherend, the bonded state prediction system comprising:
a data acquirer that acquires two or more pieces of data including physical property value information on two dimensional coordinates of the object; and
a bonded state predictor that predicts a bonded state between the object and the adherend using the acquired two or more pieces of data.

2. The bonded state prediction system according to claim 1, wherein the data acquirer acquires two dimensional coordinate information of the object, and acquires data including the two or more pieces of data including physical property value information in association with the acquired two dimensional coordinate information.

3. The bonded state prediction system according to claim 2, wherein the data acquirer includes:
an image acquirer that acquires an image indicating a state of light reflected or emitted by the object when irradiated with light; and
a processor that acquires the two or more pieces of data of the object from the acquired image.

4. The bonded state prediction system according to claim 3, further comprising:
a light source that irradiates the object with light; and
an imager that captures an image of a light emission state of the object that emits light by receiving the light from the light source,
wherein the image acquirer acquires the image captured by the imager.

5. The bonded state prediction system according to claim 1, wherein the bonded state predictor predicts the bonded state based on a prediction model of machine learning.

6. The bonded state prediction system according to claim 1 further comprising a display that displays a result predicted by the bonded state predictor.

7. The bonded state prediction system according to claim 1, wherein the two or more pieces of data are data including predetermined physical property value information acquired over time.

8. The bonded state prediction system according to claim 1, wherein the two or more pieces of data include different types of physical property value information.

9. The bonded state prediction system according to claim 8, wherein the two or more pieces of data are acquired simultaneously.

10. The bonded state prediction system according to claim 1, wherein at least one of the two or more pieces of data is spectral characteristic information of the object.

11. The bonded state prediction system according to claim 10, wherein the spectral characteristic information is acquired from an image indicating a state of light reflected or emitted by the object when the object is irradiated with light having a predetermined wavelength.

12. The bonded state prediction system according to claim 11, wherein the image is acquired by a hyperspectral camera.

13. The bonded state prediction system according to claim 11, wherein the object includes a contrast agent whose light emission behavior changes in accordance with a physical property of the object.

14. The bonded state prediction system according to claim 13, wherein the contrast agent emits fluorescence when irradiated with predetermined light.

15. The bonded state prediction system according to claim 10, wherein the spectral characteristic information is associated with a physical property value selected from the group consisting of elastic modulus, degree of cure, hardness, polarity, and moisture content.

16. The bonded state prediction system according to claim 15, wherein another one of the two or more pieces of data includes film thickness information.

17. The bonded state prediction system according to claim 1, wherein the object is a thermocompression bonding material, a curable material, or an adhesive material.

18. A bonded state prediction method of predicting a bonded state when an object having adhesiveness is bonded to an adherend, the bonded state prediction method comprising:
acquiring two or more pieces of data including physical property value information on two dimensional coordinates of the object; and
predicting a bonded state between the object and the adherend using the acquired two or more pieces of data.

19. A non-transitory computer readable recording medium having a bonded state prediction program stored thereon for predicting a bonded state when an object having adhesiveness is bonded to an adherend, wherein the program is executable to cause the computer to execute operations comprising:
acquiring two or more pieces of data including physical property value information on two dimensional coordinates of the object; and
predicting a bonded state between the object and the adherend using the acquired two or more pieces of data.

20. A method for producing a bonded article, comprising:
predicting a bonded state between the object having adhesiveness and the adherend by performing the prediction method according to claim 18 on the object; and
adjusting a processing condition for the object based on the predicted result.
